(19) United States
(12) Patent Application Publication
(10) Pub. No.: US 2017/0247279 A1
(43) Pub. Date: Aug. 31, 2017

(54) MANUFACTURING PROCESS FOR PRECISION AND FUSION QUALITY GLASS TUBES

(71) Applicant: CORNING INCORPORATED, Corning, NY (US)

(72) Inventors: Antoine Gaston Denis Bisson, Corning, NY (US); Allan Mark Fredholm, Vulaines sur Seine (FR); Laurent Joubaud, Paris (FR)

(21) Appl. No.: 15/509,393

(22) PCT Filed: Sep. 9, 2015
(86) PCT No.: PCT/US2015/049050

§ 371 Date: Mar. 7, 2017

Related U.S. Application Data
(60) Provisional application No. 62/047,879, filed on Sep. 9, 2014.

(51) Int. Cl. C03B 17/02; C03B 17/04

(52) U.S. Cl. CPC C03B 17/025; C03B 17/04

(57) ABSTRACT

The present invention is directed to methods for making high quality glass tubes, and apparatuses for making high quality glass tubes. Because glass tubes made using the methods and apparatuses disclosed herein are substantially free from the optical defect known as paneling, the glass tubes may be used in displays for consumer electronic devices. The glass tubes are made by a continuous process in which a flow of molten glass is provided on an inner surface of a hollow, rotating mandrel such that the glass coats the inner surface of the mandrel and flows downstream on the inner surface of the mandrel, during which it is cooled to provide a higher viscosity. The glass is then removed from the mandrel and drawn to obtain a glass tube. A flow of molten glass may also be provided on the outer surface of the mandrel and joined with the glass flow on the inner surface of the mandrel when the glass flows exit the mandrel. The apparatuses presented herein are configured to provide high quality glass tubes using this method.

This application claims the benefit of priority under 35 U.S.C. §119 of U.S. Provisional Application Ser. No. 62/047,879, filed on Sep. 9, 2014, the content of which is relied upon and incorporated herein by reference in its entirety.

### BACKGROUND

The disclosure relates to a method and apparatus for the manufacture of glass tubes having high optical clarity, and more particularly to a method and apparatus configured to manufacture glass tubes that have a pristine internal surface and, in some embodiments, a pristine external surface, the pristine surfaces being free from paneling defects.

### SUMMARY

One embodiment includes a method for continuously making a glass tube by providing a flow of molten glass on an inner surface of a hollow, rotating mandrel to form a tube preform, and then drawing the preform to obtain a glass tube.

A further embodiment includes a method for continuously making a glass tube preform by providing a flow of molten glass on an inner surface of a hollow, rotating mandrel and removing a molten glass tube preform from a downstream portion of the hollow, rotating mandrel. The glass tube preform may then be drawn to provide a glass tube.

A further embodiment includes a method for continuously making a glass tube by providing both (a) a flow of molten glass on an inner surface of a hollow, rotating mandrel and (b) a flow of molten glass on an outer surface of the hollow, rotating mandrel; joining the two flows together to form a preform; and then drawing the preform to obtain a glass tube. The molten glass on the inner surface and the molten glass on the outer surface of the mandrel may have the same composition or may be of differing compositions.

A further embodiment includes a method for continuously making a glass tube preform by providing both (a) a flow of molten glass on an inner surface of a hollow, rotating mandrel and (b) a flow of molten glass on an outer surface of the hollow, rotating mandrel; and joining the two together at a downstream portion of the mandrel. The glass tube preform may then be drawn to provide a glass tube. The molten glass on the inner surface and the molten glass on the outer surface of the mandrel may have the same composition or may be of differing compositions.

A further embodiment includes a method for continuously making a glass tube by providing (a) a flow of molten glass on an inner surface of a hollow, rotating mandrel, (b) a flow of molten glass on an outer surface of the hollow, rotating mandrel, and (c) a flow of molten glass substantially above the flow of molten glass on the outer surface of the hollow, rotating mandrel; joining the flows together to form a preform; and then drawing the preform to obtain a glass tube. The molten glass on the inner surface and the molten glass on the outer surface of the mandrel may have the same composition or may be of differing compositions. The molten glass that is substantially above the molten glass on the outer surface of the mandrel desirably has a composition that is different from the molten glass on the outer surface of the mandrel.

A further embodiment includes a method for continuously making a glass tube preform by providing (a) a flow of molten glass on an inner surface of a hollow, rotating mandrel, (b) a flow of molten glass on an outer surface of the hollow, rotating mandrel, and (c) a flow of molten glass substantially above the flow of molten glass on the outer surface of the hollow, rotating mandrel; and joining the flows together to form a preform. The glass tube preform may then be drawn to provide a glass tube. The molten glass on the inner surface and the molten glass on the outer surface of the mandrel may have the same composition or may be of differing compositions. The molten glass that is substantially above the molten glass on the outer surface of the mandrel desirably has a composition that is different from the molten glass on the outer surface of the mandrel.

A further embodiment includes an apparatus for making a glass tube preform comprising a hollow mandrel, a device for rotating the hollow mandrel, and a delivery device for delivering molten glass to an inner surface of the hollow mandrel. The apparatus is configured such that molten glass flows longitudinally along the inner surface of the mandrel from the point of delivery to an exit point at a downstream end of the mandrel. The hollow mandrel may be cylindrical or conical.

A further embodiment includes an apparatus for making a glass tube preform comprising a hollow mandrel, a device for rotating the hollow mandrel, a delivery device for delivering molten glass to an inner surface of the hollow mandrel, and a delivery device for delivering molten glass to an outer surface of the hollow mandrel. The apparatus is configured such that molten glass flows longitudinally along the inner surface of the mandrel from the point of delivery to an exit point at a downstream end of the mandrel. The apparatus is also configured such that molten glass flows longitudinally along the outer surface of the mandrel from the point of delivery to an exit point at a downstream end of the mandrel.

A further embodiment includes an apparatus for making a glass tube preform comprising a hollow mandrel, a device for rotating the hollow mandrel, and a delivery device for delivering molten glass to an outer surface of the hollow mandrel. The apparatus is configured such that molten glass flows longitudinally along the outer surface of the mandrel from the point of delivery to an exit point at a downstream end of the mandrel. The apparatus is further configured such that molten glass is delivered to an inner surface of the mandrel by having a portion of the molten glass that is delivered to the outer surface of the mandrel flow through one or more openings in the mandrel wall and into the interior of the hollow mandrel where it contacts the inner surface of the hollow mandrel. The apparatus is configured such that molten glass flows longitudinally along the inner surface of the mandrel from the point of delivery to an exit point at a downstream end of the mandrel.

A further embodiment includes an apparatus for making a glass tube preform comprising a hollow mandrel, a device for rotating the hollow mandrel, and a delivery device for delivering molten glass to an inner surface of the hollow mandrel. The apparatus is configured such that the longitudinal axis of the mandrel forms an angle that is between about 45 degrees and about 90 degrees from horizontal, and wherein molten glass flows along the inner surface of the mandrel longitudinally from the point of delivery to an exit point at a downstream end of the mandrel. The apparatus is also configured such that inner surface of the mandrel to which the molten glass is delivered is sloped inward to provide an angle from horizontal that is less than the angle formed by the longitudinal axis.

A further embodiment includes an apparatus for making a glass tube preform comprising a hollow mandrel, a device for rotating the hollow mandrel, a delivery device for delivering molten glass to an inner surface of the hollow mandrel, and a delivery device for delivering molten glass to an outer surface of the hollow mandrel. The apparatus is configured such that molten glass flows longitudinally along the inner surface of the mandrel from the point of delivery to an exit point at a downstream end of the mandrel. The apparatus is also configured such that molten glass flows longitudinally along the outer surface of the mandrel from the point of delivery to an exit point at a downstream end of the mandrel. The apparatus is configured such that the longitudinal axis of the mandrel forms an angle that is between about 45 degrees and about 90 degrees from horizontal. The apparatus is also configured such that inside surface of the mandrel to which the molten glass is delivered is sloped inward to provide an angle from horizontal that is less than the angle formed by the longitudinal axis. The apparatus is also configured such that the outer surface of the mandrel to which the molten glass is delivered is sloped outward to provide an angle from horizontal that is less than the angle formed by the longitudinal axis.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is an image of a prior art glass tube, demonstrating the image distortion caused by paneling defects.

FIG. 2 is an image of a prior art glass tube subjected to xenon light shadowgraphy, demonstrating paneling defects.

FIG. 3 is an image of a glass tube prepared in accordance with an embodiment of the method described herein subjected to xenon light shadowgraphy, demonstrating the lack of paneling defects.

FIG. 4 is a perspective view, in section, of an embodiment of an apparatus for making a glass tube preform.

FIG. 5 is a perspective view, in section, of an embodiment of an apparatus for making a glass tube preform, in which molten glass may flow on both an inside surface of the mandrel and an outside surface of the mandrel.

FIG. 6 is a perspective view, in section, of an embodiment of an apparatus for making a glass tube preform, in which molten glass may flow on both an inside surface of the mandrel and an outside surface of the mandrel.

FIG. 7A is a perspective view, in section, of an embodiment of an apparatus for making a glass tube preform, wherein the molten glass is delivered to an outside surface of the mandrel and flows through one or more openings in the mandrel to an inside surface of the mandrel.

FIG. 7B is a perspective view of an embodiment of a mandrel configured for use in the embodiment shown for example in FIG. 7A.

FIG. 8 is a perspective view, in section, of an embodiment of an apparatus for making a glass tube preform, wherein the mandrel is in a quasi-vertical orientation.

FIG. 9 is a perspective view, in section, of an embodiment of an apparatus for making a glass tube preform, in which molten glass may flow on both an inside surface of the mandrel and an outside surface of the mandrel, and wherein the mandrel is in a quasi-vertical orientation.

FIG. 10 is a perspective view, in section, of an embodiment of an apparatus for making a glass tube preform having a three-layer structure.

FIG. 11 is an illustration of an embodiment of a method for forming a glass tube.

### DETAILED DESCRIPTION

Reference will now be made in detail to certain embodiments, examples of which are illustrated in the accompanying drawings. Whenever possible, the same reference numerals will be used throughout the drawings to refer to the same or like parts.

### High-Quality Glass Tubes

Glass tubes find use in a variety of applications. Glass tubes are used in, for example, lighting devices, solar collectors, chemical distillation systems, flow meters, pharmaceutical packaging, and architectural design. Most notably, glass tubes have recently found use in consumer electronic devices. When used in connection with a display in a consumer electronic device, it is important that the glass does not distort the image on the display. Accordingly, at least for these applications, the optical clarity of the glass is an extremely important characteristic.

Conventionally, glass tubes are typically made using a process invented by Edward Danner in 1917 and described in U.S. Pat. No. 1,219,709, which is commonly referred to as the “Danner process.” In the Danner process, a continuous flow of molten glass is dispensed from a delivery device onto the outer surface of a mandrel, which is placed on a steel shaft rotating around its longitudinal axis. The mandrel is inclined in relation to the horizontal so that, under the forces of gravity and due to the rotating motion of the mandrel, the molten glass progressively takes the shape of a tube. The glass is progressively cooled as it flows down the mandrel towards the downstream end. After exiting the mandrel at the downstream end, the preformed tube is drawn horizontally by a drawing machine while air is blown through the inside of the tube. In the Danner process, the molten glass that is in contact with the mandrel, i.e. the glass at the interface of the mandrel and the glass flow, goes on to form the interior surface of the glass tube.

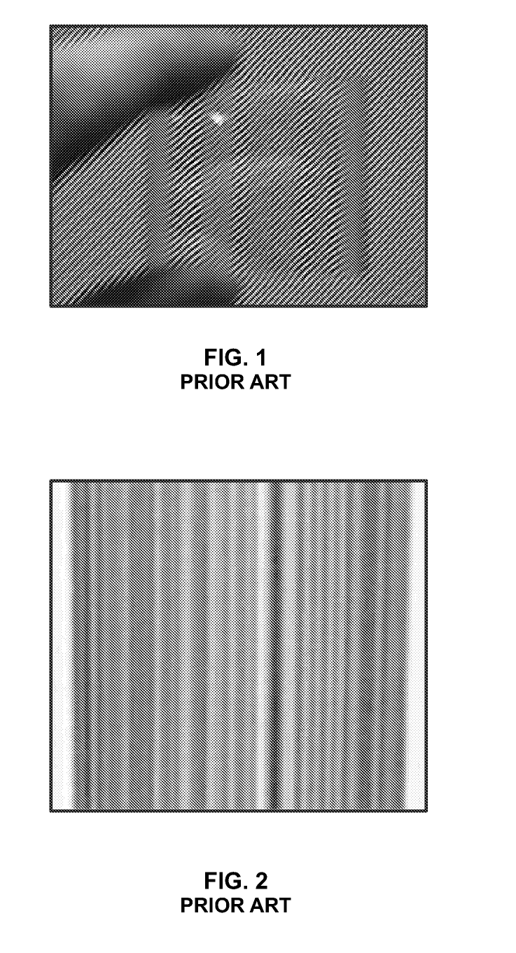

Commercially available glass tubes suffer from an optical defect known as paneling. When an image is viewed through the glass tube or a portion of the glass tube, paneling causes distortion of the image, such as the type illustrated in FIG. 1. Without being bound by theory, paneling defects are thought to be caused during the manufacture of a glass tube by the interaction between molten glass and the surfaces of the manufacturing apparatus over which the molten glass flows. The flow of the molten glass over a tooling surface is thought to impart the glass at the interface with the tooling surface with a roughness that remains on the surface of the finished glass tube product. These optical defects can be costly and difficult to remove, especially when located on the interior surface of a glass tube, which is often difficult to polish.

By manufacturing glass tubes using embodiments of the method and apparatus of the present invention, tubes having a high optical clarity can be formed. By high optical clarity it is meant that a glass tube made in accordance with embodiments of the present invention has no distortion visible to the human eye as a result of paneling defects. For example, a glass tube made in accordance with the present invention will desirably be free from image distortion, such as the distortion illustrated in FIG. 1.

Paneling can be observed and measured through a process known as shadowgraphy. In shadowgraphy, a bright light is transmitted through the sample and onto a projection screen. If the glass sample contains areas that refract the light, those areas will be visible as a dark area on the projection screen. As illustrated in FIG. 2, paneling defects are visible as one or more dark streaks. The streaks are generally oriented in the longitudinal direction of the glass tube. The image in FIG. 2 was produced by transmission of a xenon lamp through a sample of a commercially available glass tube and onto a non-transparent white projection screen.

When testing a glass tube in its entirety via shadowgraphy, one observes the transmission of light through the exterior surface, through each side of the interior surface, and through the exterior surface on the opposite side of the tube. The testing of a particular surface of a glass tube for paneling defects may be performed using the same shadowgraphy method described above by coating the other, i.e. non-tested, surfaces with an index-matching liquid. The index-matching liquid provides that there will be little to no distortion of light through the coated surface. Therefore, any distortion effects seen through shadowgraphy will be attributable to the non-coated, i.e. tested, surfaces.

The index-matching liquid should have a refractive index that is similar to the refractive index of glass. Accordingly, silicon oils may be used as the index-matching liquid. The index-matching liquid is deposited on the non-tested surfaces of the glass tube and, without being bound by theory, is believed to fill in the small voids that give rise to the roughness of the glass surface, thereby providing a smooth and level surface.

Accordingly, by coating the exterior of a glass tube with an index-matching liquid, the interior surface of the tube may be tested for paneling defects. It has generally been found that the interior surface of a glass tube made by the Danner process contains paneling defects.

It has been found that manufacture of glass tubes using embodiments of the presently disclosed method and apparatus may provide glass tubes having at least an interior surface that is substantially free from paneling defects. Desirably, the glass tube comprises a pristine interior surface, i.e. one that contains no visible paneling defects when observed using shadowgraphy. No additional processing or polishing is necessary in order to provide the high optical quality interior surface made using embodiments of the present invention.

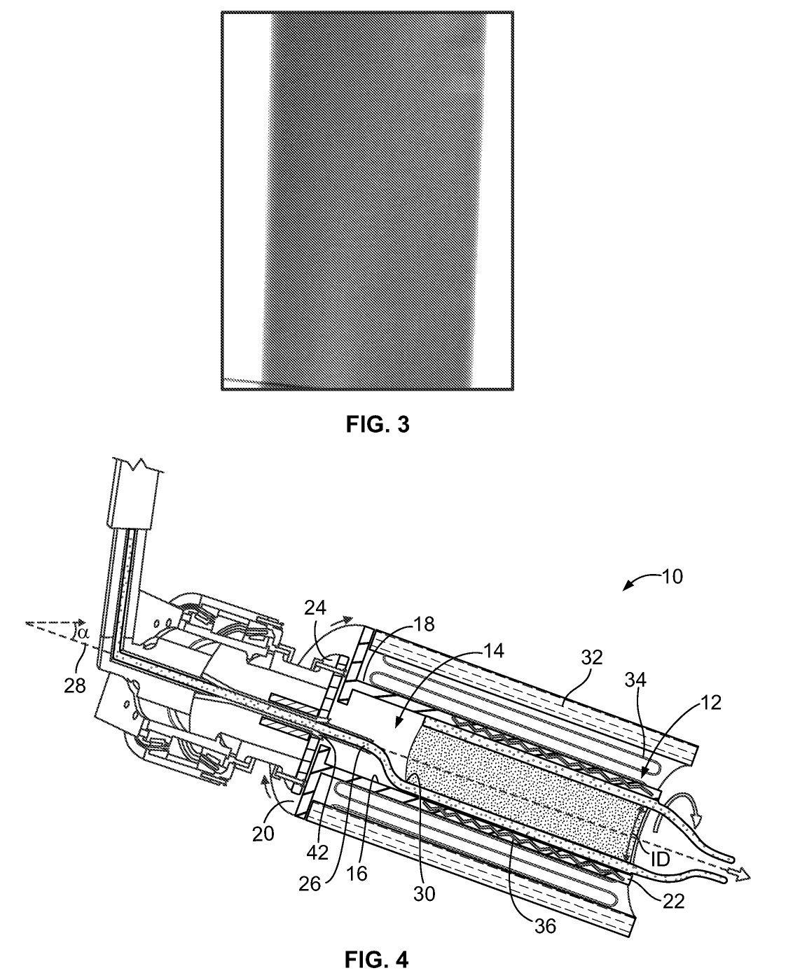

A sample of glass tube made in accordance with an embodiment of the present invention was subjected to shadowgraphy as described above. The exterior surface of the sample was coated with a silicon oil, which functioned as an index-matching oil, so that the interior surface of the glass tube was tested for paneling defects. The result is illustrated in FIG. 3. Notably, no paneling defects were identified.

Embodiments of the presently disclosed method and apparatus may also provide glass tubes having both an interior surface that is substantially free from paneling defects and an exterior surface that is substantially free from paneling defects. Desirably, the glass tube comprises both a pristine interior surface (an interior surface containing no paneling defects) and a pristine exterior surface (an exterior surface containing no paneling defects). In this way, embodiments of the presently disclosed method and apparatus may provide glass tubes that are substantially free from paneling defects. No additional processing is needed in order to provide the high optical quality interior and exterior surfaces made using embodiments of the present invention.

Some glass tubes manufactured using embodiments of the presently disclosed method and apparatus, such as tubes which might be particularly useful in consumer electronic devices, may have an outer diameter between about 1 mm and about 100 mm, alternatively between about 5 mm and about 80 mm, alternatively between about 10 mm and about 60 mm, alternatively between about 10 mm and about 50 mm, alternatively between about 10 mm and about 40 mm, alternatively between about 10 mm and about 30 mm, alternatively between about 10 mm and about 20 mm. The wall thickness of these tubes may be between about 0.2 mm and about 10 mm, alternatively between about 0.5 mm and about 5 mm, alternatively between about 0.5 mm and about 2 mm.

The presently disclosed manufacturing process and apparatus provides for a high level of control over the thickness of the glass tubes. Thickness control is generally determined by measuring the thickness of the glass tube wall at different sections along its length and calculating the variance from the desired thickness. The thickness of glass tubes manufactured using embodiments of the presently disclosed method and apparatus may vary by less than 5% from the desired thickness. Alternatively, the thickness of glass tubes manufactured using embodiments of the presently disclosed method and apparatus may vary by less than 4% from the desired thickness, alternatively less than 3%, alternatively less than 2%, and alternatively less than 1%.

### Apparatus for the Manufacture of High-Quality Glass Tubes

An embodiment of an apparatus for manufacturing glass tube preforms is shown in FIG. 4, and is designated generally throughout by the reference numeral 10. The apparatus 10 comprises a mandrel 12, the mandrel comprising a hollow interior 14 that is bounded by an inner surface of the mandrel 16. The mandrel 12 also comprises an outer surface 18. In the embodiment illustrated in FIG. 4, the mandrel 12 is shaped as a cylinder that spans longitudinally between an upstream end 20 and a downstream end 22. The downstream end 22 is also sometimes known as the root end.

The mandrel 12 is made of a material that is resistant to high temperatures. Accordingly, refractory materials such as the type that are known as being suitable for construction of the mandrel in the conventional Danner process may be used as the material of the mandrel 12. For example, the mandrel 12 may be made of an alumina-silicate. In some embodiments, the mandrel 12 may also comprise a platinum cladding on either the inner surface of the mandrel 16, the outer surface of the mandrel 18, or both the inner and outer surfaces of the mandrel.

The mandrel 12 is configured so that the forces of gravity will induce molten glass to flow along at least the inner surface 16 between a point of delivery 30 at or near the upstream end of the mandrel 20 to a point of exit at the downstream end of the mandrel 22. Accordingly, the mandrel 12 may be inclined such that its longitudinal axis 28 forms an angle α with a horizontal axis. The angle α is preferably between about 5° and about 90°. Although not limited to such use, the mandrel 12 shown in FIG. 4 may be particularly suitable for use at an angle α between about 5° and about 60°. In the embodiment shown in FIG. 4, for example, the angle α is about 20°.

The diameter of the mandrel 12 at the root end 22 plays a key role in determining the diameter of the glass tube produced on the apparatus. Accordingly, the diameter of the mandrel 12, and particularly the diameter of the mandrel at the root end 22, may be selected in order to produce a glass tube having a desired size. In some embodiments, the inner diameter of the mandrel at the root end, labeled ID in FIG. 4, may be between about 80 mm and about 500 mm, alternatively between about 100 mm and about 400 mm, alternatively between about 100 mm and about 300 mm, alternatively between about 100 mm and about 250 mm, alternatively between about 100 mm and about 220 mm.

The apparatus 10 also comprises a device 24 configured to rotate the mandrel. The rotating device 24 may comprise any device known in the art as being suitable for rotating a mandrel, such as those that may be used in the conventional Danner process. In some embodiments, such as that illustrated in FIG. 4, the device 24 may be configured such that molten glass passes through the device before being delivered to the hollow interior 14 of the mandrel. In this instance, the device 24 may generally comprise a delivery tube that is surrounded by an insulating material, which prevents heat damage to the rest of the device. The device 24 is desirably configured to rotate the mandrel at a speed of at least about 2 rpm and more desirably up to at least about 20 rpm.

The apparatus 10 also comprises a delivery device 26 configured to deliver molten glass to an inside surface of the hollow mandrel. The delivery device 26 may be any device known in the art as being suitable for delivering molten glass, such as those used in delivering molten glass to the outer surface of a mandrel in the conventional Danner process. As described above, the delivery device 26 may be configured such that it passes through a portion of the rotating device 24. The delivery devices 26 deposits molten glass into the hollow interior 14 of the mandrel at a delivery point 30, which is desirably at or near the upstream end of the mandrel 20. The mandrel 12 is configured such that the rotation of the mandrel causes the molten glass delivered to the interior of the mandrel 14 to coat the circumference of the inner surface 16 of the mandrel, desirably soon after the delivery point 30.

The apparatus 10 may also comprise an external casing, or muffle 32, which surrounds the mandrel 12 along its length. In some embodiments, the muffle 32 may comprise a cooling element 34, the cooling element being configured for cooling the molten glass as it flows downstream along the length of the mandrel 12. The cooling element 34 may comprise, for example, a heat exchanger or a series of heat exchangers. For some uses, however, heat exchangers within the muffle may alone be insufficient for the cooling of the glass flow on the inner surface of the mandrel 16, as the wall of the mandrel itself can act as insulation against the effects of the cooling elements 34.

Embodiments of the mandrel 12 may comprise a cooling element 36 within the mandrel, e.g. within the wall of the mandrel. This cooling element 36 may either take the place of the cooling element of the muffle 34, or work in tandem with to the cooling element of the muffle 34. The cooling element 36 is configured to provide a degree of temperature control to the inner surface of the mandrel 16. As shown in FIG. 4, the cooling element 36 may provide circulation of a cooling liquid, such as water, or a cooling gas, such as air, within the wall of the mandrel 12. The cooling element 36 may be particularly advantageous for cooling the glass flow when high flow rates of glass are used and/or where the mandrel has a short length.

The apparatus 10 may also comprise a device 42 configured to deliver pressurized gas to the hollow interior of the mandrel 14. The gas delivery device 42 may be any device known in the art as being suitable for delivering gas, such as those used in delivering gas to the outer surface of a mandrel in the conventional Danner process. As with the delivery of molten glass to the hollow interior of the mandrel 14, the gas delivery device 42 may be configured such that it passes through a portion of the rotating device 24, as illustrated in FIG. 4. For example, the device 42 may comprise one or more apertures located radially outward from the molten glass delivery device 26.

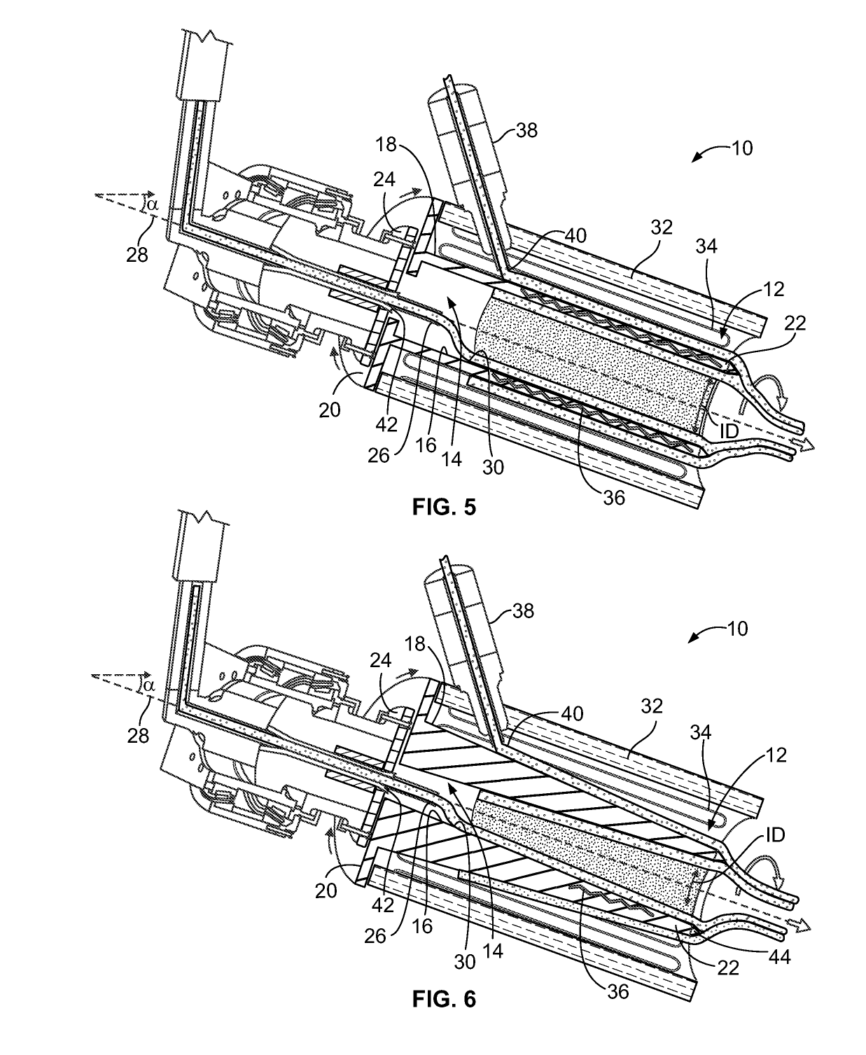

Another embodiment of an apparatus for continuously manufacturing a glass tube preform is shown in FIG. 5. As shown in FIG. 5, the apparatus may also comprise a delivery device 38 configured to deliver molten glass to the outer surface 18 of the mandrel. The delivery device 38 may be any device known in the art as being suitable for delivering molten glass, such as those used in delivering molten glass to the outer surface of a mandrel in the conventional Danner process. The delivery device 38 deposits molten glass onto the outer surface 18 of the mandrel at a delivery point 40, which is desirably at or near the upstream end of the mandrel 20. The mandrel 12 is configured such that the rotation of the mandrel causes the molten glass delivered to the outer surface of the mandrel 18 to coat the circumference of the outer surface 18, desirably soon after the delivery point 40.

The mandrel 12 is configured so that the forces of gravity will induce molten glass to flow along the outer surface 18 between the point of delivery 40, which is desirably at or near the upstream end of the mandrel 20, to a point of exit at the downstream end of the mandrel 22. In embodiments configured for the flow of molten glass on both the inner surface of the mandrel 16 and the outer surface of the mandrel 18, the downstream end of the mandrel 22 may be configured to bring about a joining of the two glass flows at the point where they exit the mandrel. As illustrated in FIG. 5, for example, the downstream end of the mandrel, or root end 22, may be configured to terminate at a tip 44. By bringing the flow of glass on the inner surface 16 and the flow of glass on the outer surface 18 together at the tip 44, the apparatus may enhance the fusing together of the two glass streams.

Another embodiment of an apparatus 10 for continuously manufacturing a glass tube preform is shown in FIG. 6. As shown in FIG. 6, the mandrel 12 may be configured to have a conical shape, wherein the diameter of the mandrel is larger at the upstream end 20 than the diameter of the mandrel at the downstream end 22. The conical configuration can be achieved by having a mandrel 12 in which the thickness of the mandrel wall decreases moving downstream along the longitudinal axis. A mandrel 12 having a conical configuration may be particularly desirable where the apparatus is configured for the flow of glass on both the inner surface 16 and outer surface 18 of the mandrel. By providing a mandrel 12 having a conical configuration, one is able to bring the glass flows on the inner surface 16 and outer surface 18 of mandrel closer together toward the downstream end of the mandrel 22, thereby decreasing the sharpness of the sloping required to produce the tip 44.

Where the mandrel 12 is conical, the degree of narrowing may sometimes be described in terms of an angle β. The angle β may be measured by determining the diameter of the mandrel 12 at the root end 22, the diameter of the mandrel at the delivery point 30, and the length of the mandrel between these two points. Using this information, the angle β may then be calculated using the following equation:

$$β = 1 \text{/} 2 \times \frac{diameter at the delivery - diameter at the root}{length between the delivery and t he root}$$

In some embodiments, the angle β may be between about 0.5 and about 5 degrees, alternatively between about 0.5 and about 4 degrees, alternatively between about 0.5 and about 3 degrees.

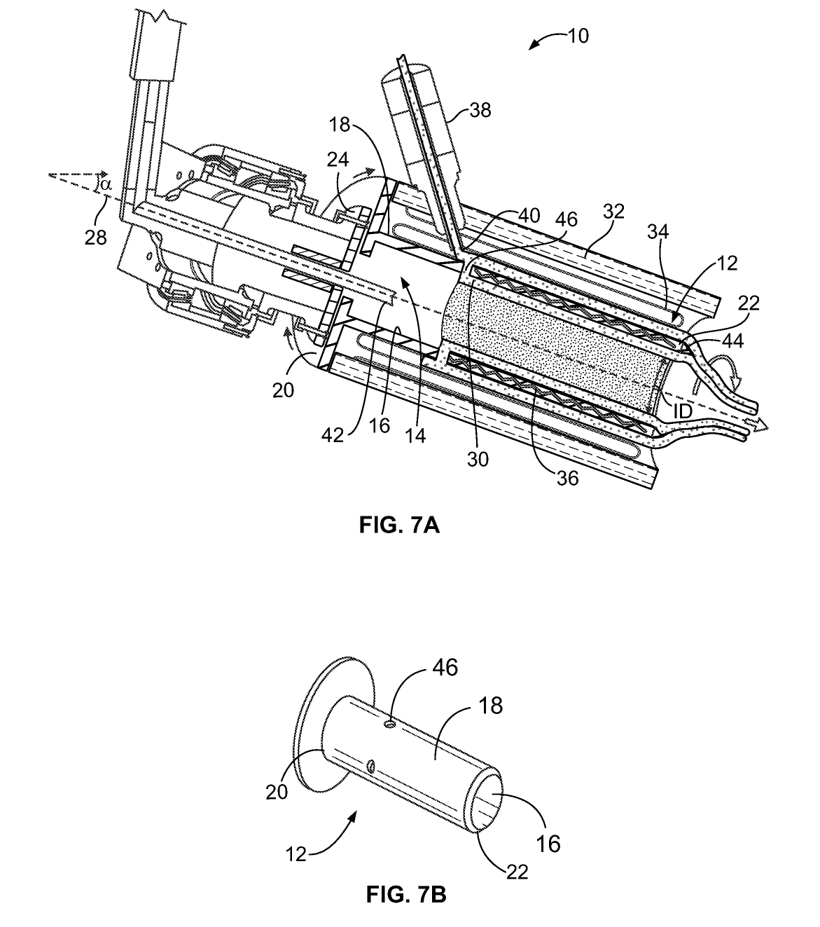

Another embodiment of an apparatus 10 for continuously manufacturing a glass tube preform is shown in FIG. 7. As shown in FIG. 7, the apparatus 10 is configured such that the delivery device 26 configured to deliver molten glass to the hollow interior 14 of the mandrel, and thus to the inner surface of the mandrel 16, comprises the combination of a delivery device configured to deliver molten glass to an outer surface of the hollow mandrel 38 and one or more openings 46 in the mandrel wall, the one or more openings being configured to provide for the flow of molten glass from the outer surface 18 of the mandrel, through the wall of the mandrel 12, and to an inner surface 16 of the mandrel. The one or more openings 46 are desirably located at or soon after the delivery point 40. Some embodiments comprise a plurality of openings 46 that are spaced substantially evenly around the circumference of the mandrel 12. The sizes and spacing of the openings may be selected in order to provide a desired flow of glass into the hollow interior 14 of the mandrel, and hence a desired flow of glass on the inner surface 16, as well as a desired flow of glass on the outer surface 18 of the mandrel.

This configuration may be particularly useful for implementation with an already-existing conventional Danner system. For example, using this configuration, one may be able to update a conventional Danner system to include molten glass flow on the inner surface 16 simply by replacing the mandrel 12.

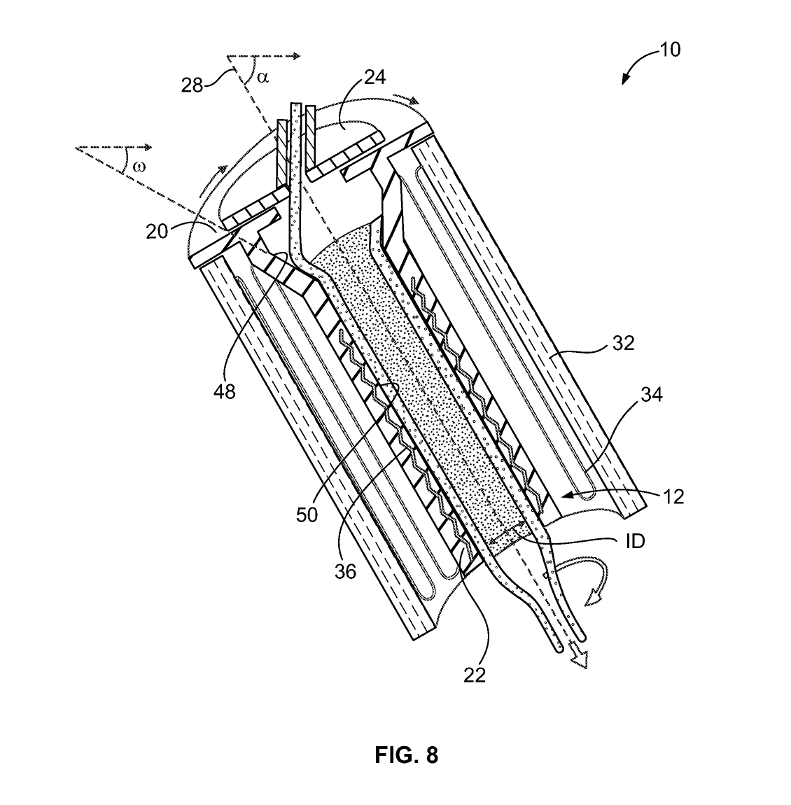

Another embodiment of an apparatus 10 for continuously manufacturing a glass tube preform is shown in FIG. 8. As shown in FIG. 8, the apparatus 10 may be configured such that the mandrel is inclined to be quasi-vertical. For example, the mandrel 12 may be included such that the angle α formed between the longitudinal axis 28 of the mandrel and horizontal is between about 55° and about 90°, alternatively between about 60° and about 90°. The inclining of the mandrel 12 to angles within these ranges may be particularly useful for producing a thick glass tube and/or a glass tube having a large diameter. It may also be particularly useful where using a low flow rate of glass through the mandrel 12.

Where the angle α is above a certain threshold, it becomes difficult to achieve a consistent and continuous coating across the entire circumference of the inner surface 16 of the mandrel. Accordingly, in some embodiments and especially where the angle α is high, the mandrel 12 may comprise an inner surface 16 that includes a first, or delivery, portion 48, and a second, or flow, portion 50.

The delivery portion 48 is sloped inward toward the center of the mandrel in order to provide the first portion with an angle ω from horizontal that is lower than the angle α. The delivery portion 48 is configured such that the angle ω is below the threshold angle at which the coating of the inner surface 16 by the molten glass flow becomes inconsistent and/or discontinuous. For example, in some embodiments, the angle ω is less than 60° from horizontal, alternatively less than 55° from horizontal. The apparatus 10 is configured such that the delivery device 26 delivers the molten glass to the first portion of the inner surface 48. Accordingly, as the molten glass flow travels along the first portion of the inner surface 48, the rotation of the mandrel 12 causes the molten glass to produce a consistent and continuous coating of the circumference of the inner surface 16 of the mandrel.

The flow portion 50 may be sloped to provide an angle from horizontal that is equal to or greater than the angle α, in order to provide the benefits of the quasi-vertical mandrel configuration. For instance, the flow portion 50 may be sloped to provide an angle from horizontal that is above the threshold angle at which the coating of the inner surface 16 by the molten glass flow becomes inconsistent and/or discontinuous. This is because the circumference of the inner surface 16 has already been provided with a consistent and continuous coating of molten glass due to the flow of molten glass across the first portion 48. For example, in some embodiments, the angle formed by the second portion 50 of the inner surface is greater than 55° from horizontal, alternatively greater than 60° from horizontal. As illustrated in FIG. 8, the portion of the mandrel that comprises the second portion 50 of the inner surface may be cylindrical. In some embodiments, however, the portion of the mandrel that comprises the second portion 50 of the inner surface may also be conical.

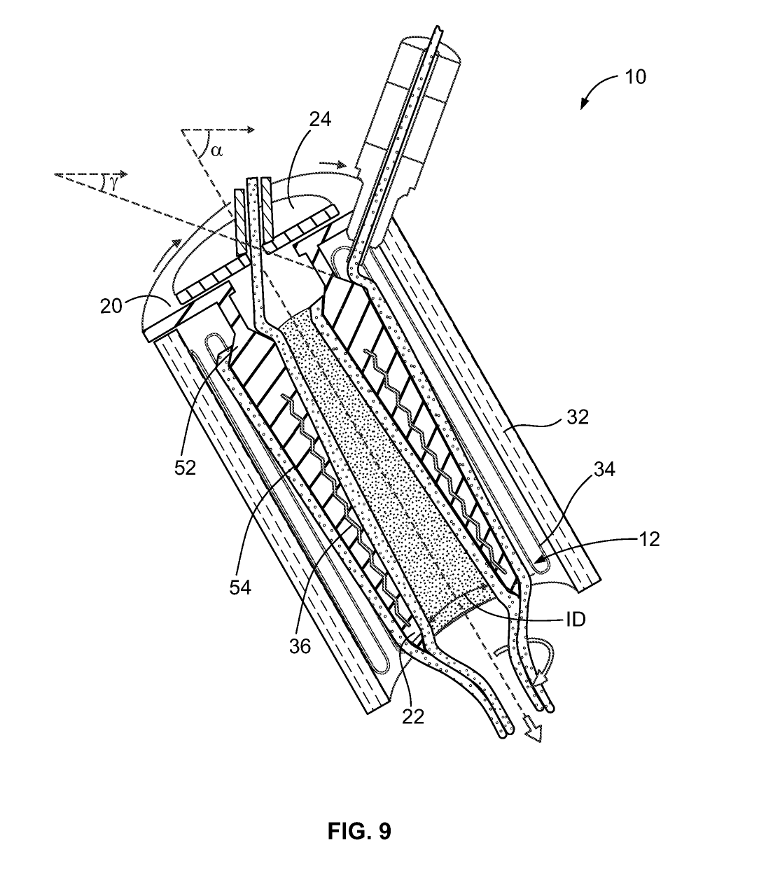

Another embodiment of an apparatus 10 for continuously manufacturing a glass tube preform is shown in FIG. 9. As described above regarding the coating of the inner surface of the mandrel 16, where the angle α is above a certain threshold, it also becomes difficult to achieve a consistent and continuous coating across the entire circumference of the outer surface 18 of the mandrel. Accordingly, in some embodiments, and especially where the angle α is high, the mandrel 12 may comprise an outer surface 18 that includes a first portion 52, or delivery portion, and a second portion 54, or flow portion.

The first portion 52 is sloped outward away from the center of the mandrel in order to provide the first portion with an angle γ from horizontal that is lower than the angle α. The first portion 52 is configured such that the angle γ is below the threshold angle at which the coating of the outer surface 18 by the molten glass flow becomes inconsistent and/or discontinuous. For example, in some embodiments, the angle γ is less than 60° from horizontal, alternatively less than 55° from horizontal. The apparatus is configured such that the delivery device 38 delivers the molten glass to the first portion of the outer surface 52. Accordingly, as the molten glass flow travels along the first portion of the outer surface 52, the rotation of the mandrel 12 causes the molten glass to produce a consistent and continuous coating of the circumference of the outer surface 18 of the mandrel.

The second portion 54 may be sloped to provide an angle from horizontal that is equal to or greater than the angle α, in order to provide the benefits of the quasi-vertical mandrel configuration. For instance, the second portion 54 may be sloped to provide an angle from horizontal that is above the threshold angle at which the coating of the outer surface 18 by the molten glass flow becomes inconsistent and/or discontinuous. This is because the circumference of the outer surface 18 has already been provided with a consistent and continuous coating of molten glass due to the flow of molten glass across the first portion 52. For example, in some embodiments, the angle formed by the second portion 54 of the outer surface is greater than 55° from horizontal, alternatively greater than 60° from horizontal. As illustrated in FIG. 9, the portion of the mandrel that comprises the second portion 54 of the outer surface may be conical. In some embodiments, however, the portion of the mandrel that comprises the second portion 54 of the outer surface may also be cylindrical.

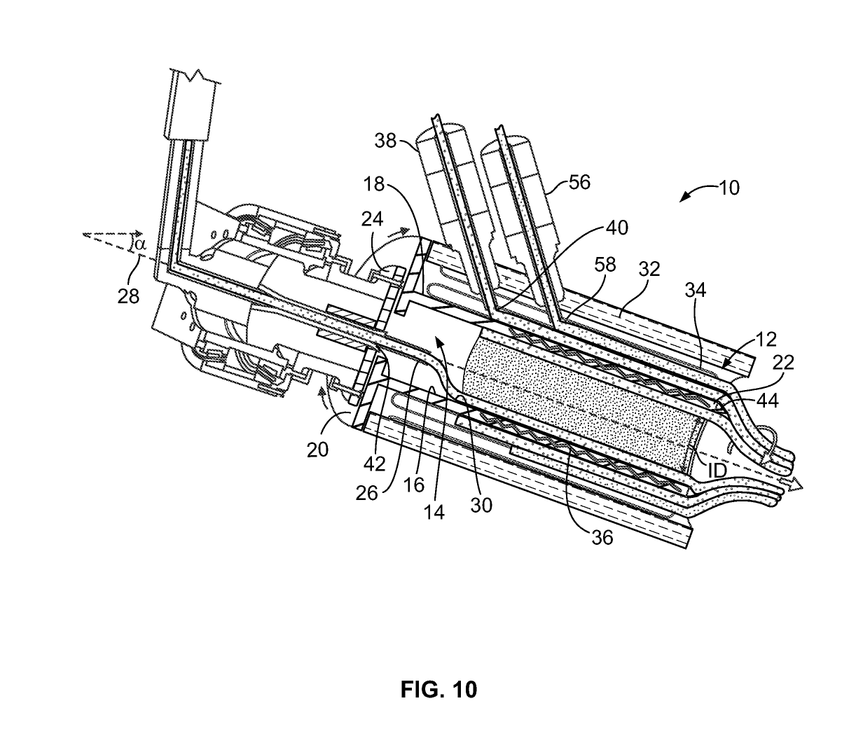

Another embodiment of an apparatus 10 for continuously manufacturing a glass tube preform is shown in FIG. 10. As illustrated in FIG. 10, the apparatus 10 may further comprise a delivery device 56 configured to deliver an additional flow of molten glass to the outer surface 18 of the mandrel. The delivery device 56 may be any device known in the art as being suitable for delivering molten glass, such as those used in delivering molten glass to the outer surface of a mandrel in the conventional Danner process. The delivery device 56 is configured to deliver molten glass at a delivery point 58. As illustrated in FIG. 10, the delivery point 58 is downstream from delivery point 40, at which the delivery device 38 is configured to provide a flow of molten glass to the outer surface of the mandrel 18. Accordingly, the delivery device 56 is configured to deliver and provide a flow of molten glass above the surface of the molten glass flowing on the outer surface of the mandrel 18.

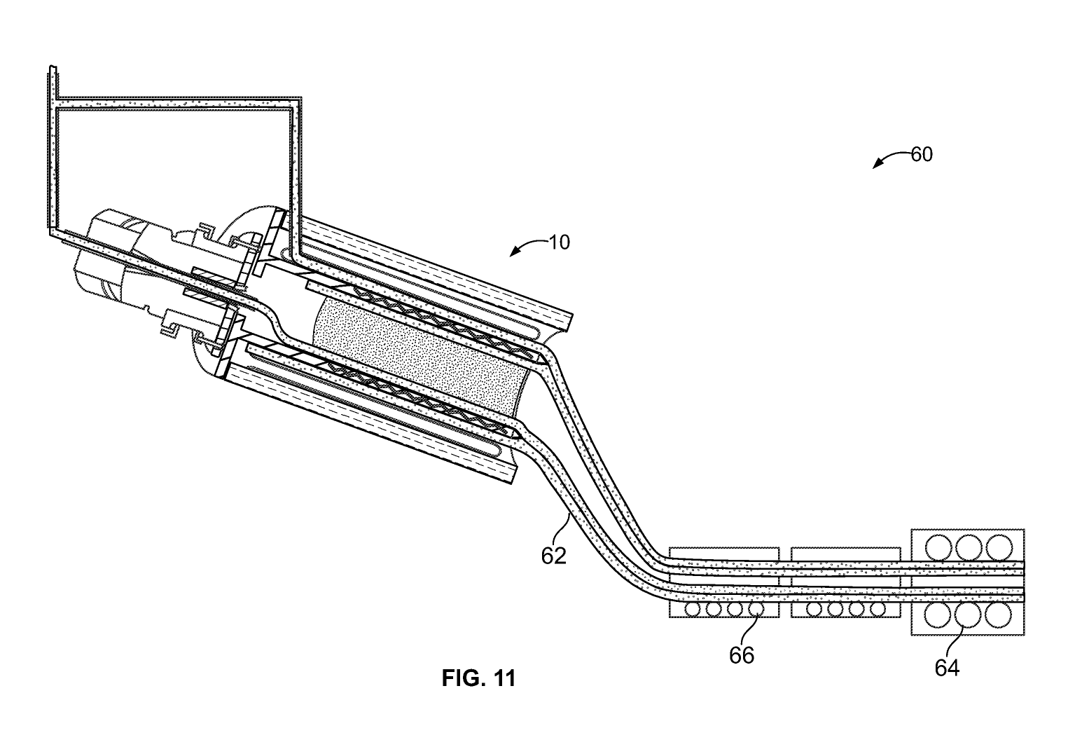

An embodiment of an apparatus 60 for continuously manufacturing a glass tube is shown in FIG. 11. As illustrated in FIG. 11, the apparatus 60 comprises an apparatus for continuously manufacturing a glass tube preform 10 according to any of the above-described embodiments. Apparatus 60 may also comprise a device 64 configured for drawing the glass tube preform that exits the mandrel 12. The drawing device 64 may comprise any devices known in the art as being suitable for drawing glass tubes. For instance, in FIG. 11, the device 64 is illustrated as being a wheel drawing machine. The apparatus 60 may also comprise a device 66 configured for conveying the glass tube preform from the exit of the mandrel 12 to the drawing device 64. The conveying device may comprise any devices known in the art as being suitable for conveying a glass tube preform. For instance, in FIG. 11, the device 66 is illustrated as comprising a series of graphite rollers. The drawing device 64 and the conveying device 66 are desirably located and configured to provide a distance 62 through which the glass tube preform exiting the mandrel 12 takes on a catenary arrangement.

The apparatuses set forth herein are not limited to the embodiments illustrated and specifically described above. Rather, certain features of the embodiments described above may be included, excluded, and combined in order to provide additional unillustrated embodiments, as would be understood by a person of skill in the art.

### Method for the Manufacture of High-Quality Glass Tubes

Another embodiment of the present invention is a method for the continuous manufacture of a glass tube having high optical clarity. Using an apparatus such as those described above and careful control over various process parameters, embodiments of the present invention may provide glass tubes having a pristine interior surface. Further, using an apparatus such as those described above and careful control over various process parameters, embodiments of the present invention may provide glass tubes having a pristine interior surface and a pristine exterior surface.

In some embodiments, a method of manufacturing a glass tube includes forming a glass tube preform and drawing the preform to obtain a glass tube. The forming of a glass tube preform comprises providing a flow of molten glass on an inner surface 16 of a hollow rotating mandrel 12 and removing a glass preform from a downstream portion of the mandrel 22.

The drawing of the glass tube preform to obtain a glass tube is a process that is generally understood by those skilled in the art. For instance, in some methods, the glass tube preform exiting a mandrel 12 may move through an area in which the preform takes on a catenary configuration 62. During its conveyance through this catenary stage, the glass preform is cooled to a temperature close to its softening point. After the catenary stage 62, the glass tube preform may be conveyed through a drawing machine 64, such as a wheel drawing machine, where the glass is further cooled to provide a solid glass tube. In some embodiments, the drawing may be performed with a draw ratio between about 3 and about 10. However, it should be understood that the glass tube preform produced by methods of embodiments described herein could be drawn in order to obtain a glass tube by any method known by persons skilled in the art, such as those used in connection with the conventional Danner process or variants thereof.

Some embodiments of the present invention are directed only toward the forming of a glass tube preform. It should be understood that the glass tube preform of these embodiments could further be drawn in order to obtain a glass tube by any method known by persons skilled in the art, including but not limited to that generally described above.

The method for making a glass tube preform comprises providing a flow of molten glass on an inner surface 16 of a hollow rotating mandrel 12 and removing a glass preform from a downstream portion of the mandrel 22. A flow of molten glass is delivered to the interior 14 of the hollow rotating mandrel 12.

The rotation of the mandrel 12 causes the molten glass stream to circumferentially coat the inside surface of the mandrel 16. The rotation of the mandrel 12 throughout the process also provides that circumferential thermal and/or flow singularities are avoided. As described above, the mandrel 12 has a longitudinal axis 28 that is inclined at an angle α from horizontal. Therefore, due to gravitational forces, the molten glass stream also flows longitudinally down the inner surface 16 of the mandrel 12, taking the shape of a tube.

In order to provide for a glass tube having a high quality interior glass surface, the molten glass stream is desirably delivered to the inner surface of the mandrel 16 at a low viscosity. The viscosity of the glass stream provided to the inner surface of the mandrel 16 is desirably less than 30 kP, alternatively less than 10 kP. For example, the viscosity of the glass stream provided to the inner surface of the mandrel 16 may be between about 1 kP and about 30 kP, alternatively between about 1 kP and about 25 kP, alternatively between about 1 kP and about 20 kP, alternatively between about 1 kP and about 15 kP, alternatively between about 1 kP and about 10 kP, and alternatively between about 1 kP and about 5 kP. Without being bound by theory, it is believed that the use of low viscosity flow provides that the glass flow may heal any surface defects to thereby provide a high quality optical surface.

The glass flow may also be cooled as it flows longitudinally along the inside surface of the rotating mandrel 16. As the glass cools during its downstream flow, the viscosity of the glass flow increases. Desirably, this process occurs gradually as the glass moves longitudinally along the mandrel 12. For example, the glass may cool at a rate between about 0.1 and 0.8° C. per millimeter of mandrel length. The glass may be cooled by a cooling element surrounding the mandrel 34 and/or by a cooling element located within the mandrel 36. For instance, a cooling element located within the mandrel wall 36 may function to cool the mandrel 12, thereby cooling the glass flow as it moves down the inner surface of the wall 16.

The viscosity of the glass flow at the root end of the mandrel 22 must be high enough to provide the glass flow with stability upon its removal from the mandrel 12 and during the subsequent drawing process. For example, the viscosity of the glass stream as it exits the root end of the mandrel 22 may be between about 80 kP (kilopoise) and about 500 kP, alternatively between about 80 kP and about 300 kP, alternatively between about 100 kP and about 300 kP, alternatively between about 100 kP and about 200 kP.

The rotation rate of the mandrel 12 may also be controlled in order to provide a glass tube having high optical quality surfaces. In some embodiments the rotation rate of the mandrel is desirably between about 2 rpm (revolutions per minute) and about 20 rpm, alternatively between about 2 rpm and about 15 rpm, alternatively between about 2 rpm and about 12 rpm, alternatively between about 2 rpm and about 10 rpm, and alternatively between about 2 rpm and about 8 rpm.

The flow rate of the glass flow longitudinally along the inside surface of the rotating mandrel 16 may also be controlled to provide a stable flow and thus a high quality glass tube. In some embodiments, the glass flow rate is between about 20 kg/h (kilograms per hour) and about 800 kg/h, alternatively between about 20 kg/h and about 700 kg/h, alternatively between about 20 kg/h and about 600 kg/h, alternatively between about 20 kg/h and about 500 kg/h, alternatively between about 20 kg/h and about 400 kg/h, alternatively between about 20 kg/h and about 300 kg/h, alternatively between about 20 kg/h and about 200 kg/h, alternatively between about 20 kg/h and about 100 kg/h.

In some embodiments, the wall thickness of the glass tube preform, and accordingly the wall thickness of the glass tube, may be further controlled by providing a gas to the interior hollow of the rotating mandrel 14. By providing a gas pressure inside the hollow of the mandrel 14, one may adjust the wall thickness of the glass tube preform exiting the mandrel 12 and thus the wall thickness of the drawn glass tube. In some embodiments, the gas pressure may be between about 1 Pa (pascal) and about 1000 Pa, alternatively between about 1 Pa and about 500 Pa, alternatively between about 0 Pa and about 300 Pa, alternatively between about 1 Pa and about 200 Pa, depending on the desired thickness of the glass tube. There are few, if any, limitations on the identity of the gas. Because of its low cost, for example, the gas may be compressed air.

By providing for the controlled flow of molten glass on the inside surface of a rotating mandrel 16, glass tubes having an interior surface that are free from paneling defects may be produced in a continuous manner. The glass tubes produced using embodiments described above may also have a consistent thickness, with a variance of less than 5% and alternatively less than 2%.

In another embodiment, molten glass is also provided to the outer surface of the hollow rotating mandrel 18. Similarly to the glass on the inside surface of the hollow mandrel 16, the rotation of the mandrel 12 causes the molten glass stream to circumferentially coat the outer surface of the mandrel 16. The rotation is also thought to provide that circumferential thermal and/or flow singularities are avoided. The gravitational forces produced by the angle of the mandrel 12 also provide a flow of the glass longitudinally down the outer surface of the mandrel 18, such that the glass flow takes the shape of a tube.

The glass flow on the outer surface of the mandrel 18 joins together with the glass flow on the inner surface of the mandrel 16 as the two flows exit the downstream end of the mandrel 22. Desirably, the mandrel 12 is configured such that the flows converge toward one another and join together at a tip of the mandrel 44.

The composition of the glass provided to the outer surface of the mandrel 18 may be the same as the composition of the glass provided to the inner surface of the mandrel 16. In other embodiments, the composition of the glass provided to the outer surface of the mandrel 18 may have a composition that differs from the composition of the glass provided to the inner surface 16 of the mandrel. By using different glass composition for the inner glass stream and the outer glass stream, one may produce a glass tube having different properties between its internal and external surface.

For some applications, for example, the glass on the outer surface of the mandrel 18, which forms the external surface of the glass tube may have a lower coefficient of thermal expansion than the glass on the inner surface of the mandrel 16, which forms the internal surface of the glass tube. For other applications, the glass on the outer surface of the mandrel 18, which forms the external surface of the glass tube may have a higher coefficient of thermal expansion than the glass on the inner surface of the mandrel 16, which forms the internal surface of the glass tube.

The use of glasses having different coefficients of thermal expansion is provided solely as an example. The individual glasses supplied to the inner surface and outer surface of the mandrel may be individually selected in order to provide any combination of properties, as would be understood by a person of skill in the art. Depending on the application, for example, it may be desirable to select a glass that provides the internal surface of the glass tube with desirable properties related to chemical inertness. For other applications, it may be desirable to select a glass that provides the external surface of the glass tube with scratch resistance properties.

In order to provide for a glass tube having a high quality exterior glass surface, the molten glass stream is desirably delivered to the outer surface of the mandrel 18 at a low viscosity. The viscosity of the glass stream provided to the outer surface of the mandrel 18 is desirably less than 30 kP, alternatively less than 10 kP. For example, the viscosity of the glass stream provided to the outer surface of the mandrel 18 may be between about 1 kP and about 30 kP, alternatively between about 1 kP and about 25 kP, alternatively between about 1 kP and about 20 kP, alternatively between about 1 kP and about 15 kP, alternatively between about 1 kP and about 10 kP, and alternatively between about 1 kP and about 5 kP.

The glass flow may also be cooled as it flows longitudinally along the outer surface of the rotating mandrel 18. As the glass cools during its downstream flow, the viscosity of the glass flow increases. Desirably, this process occurs gradually as the glass moves longitudinally along the mandrel 12. For example, the glass may cool at a rate of between about 0.1 and 0.8° C. per millimeter of mandrel length. The glass may be cooled by a cooling element surrounding the mandrel 34 and/or by a cooling element located within the mandrel 36. For instance, a cooling element located within the mandrel wall 36 may function to cool the mandrel 12, thereby cooling the glass flow as it moves down the outer surface of the wall 18.

The viscosity of the glass flow at the root end of the mandrel 22 must be high enough to provide stability to the glass flow upon its removal from the mandrel 12 and during the subsequent drawing process. For example, the viscosity of the glass stream as it exits the outer surface 18 of the root end of the mandrel 22 may be between about 80 kP and about 500 kP, alternatively between about 80 kP and about 300 kP, alternatively between about 100 kP and about 300 kP, alternatively between about 100 kP and about 200 kP.

The flow rate of the glass longitudinally along the outer surface of the rotating mandrel 18 may also be controlled to provide a stable flow and thus a high quality glass tube. In some embodiments, the glass flow rate is between about 20 kg/h (kilograms per hour) and about 800 kg/h, alternatively between about 20 kg/h and about 700 kg/h, alternatively between about 20 kg/h and about 600 kg/h, alternatively between about 20 kg/h and about 500 kg/h, alternatively between about 20 kg/h and about 400 kg/h, alternatively between about 20 kg/h and about 300 kg/h, alternatively between about 20 kg/h and about 200 kg/h, alternatively between about 20 kg/h and about 100 kg/h.

In some embodiments, the flow rate of the glass along the outer surface of the rotating mandrel 18 may be substantially the same as the flow rate of glass along the inner surface of the rotating mandrel 16. In other embodiments, it may be desirable to have either a greater flow rate along the outer surface of the mandrel 18 or a lesser flow rate of glass along the outer surface of the mandrel than that on the inner surface of the mandrel 16.

The use of a flow rate on the outer surface of the mandrel 18 that differs from the flow rate on the inner surface of the mandrel 16 may be particularly useful where, for example, the composition of the glass on the outer surface of the mandrel differs from the composition of the glass on the inner surface of the mandrel. By selection and control of the flow rates of the glass on the outer surface of the mandrel 18 and the glass on the inner surface of the mandrel 16, one may control the thicknesses of the different layers in the glass tube produced.

In some embodiments, the thickness of the wall of the glass tube preform, and accordingly the thickness of the wall of the glass tube, may be further controlled by providing a gas flow around the outer surface of the rotating mandrel 18. By providing a gas pressure around the outer surface of the mandrel 18, one may adjust the wall thickness of the final glass tube. In some embodiments, the gas pressure may be between about 1 Pa and about 1000 Pa, alternatively between about 1 Pa and about 500 Pa, alternatively between about 0 Pa and about 300 Pa, alternatively between about 1 Pa and about 200 Pa, depending on the desired wall thickness of the glass tube.

By providing for the controlled flow of molten glass on the outer surface of a rotating mandrel 18, a glass tube having an exterior surface that is free from paneling defects may be produced in a continuous manner. By providing for the controlled flow of molten glass on both the inner surface 16 and outer surface 18 of the rotating mandrel, a glass tube that is free from paneling defects may be produced in a continuous manner. The glass tube produced using embodiments described above may also have a consistent thickness, with a variance of less than 5% and alternatively less than 2%.

In another embodiment, an additional flow of molten glass may be provided to the outer surface of the rotating mandrel 18. The additional flow of molten glass is configured to provide the glass tube with an outer cladding layer. Accordingly, the additional flow of molten glass is provided downstream from the initial flow of glass on the outer surface of the mandrel 18 and is configured to remain substantially on top of the initial glass flow on the outer surface of the mandrel.

The additional flow of molten glass has a different composition than at least the initial flow of glass on the outer surface of the mandrel 18. The additional flow of molten glass may also have a different composition than the flow of glass on the inner surface of the mandrel 16. Using this embodiment, a glass tube having a three-layer structure may be continuously produced. The relative thicknesses of the three layers that make up the tube may be controlled through control of the flow rate of each glass flow on the mandrel 12, as described above.

### EXAMPLES

Various embodiments will be further clarified by the following examples.

### Example 1

Using an apparatus 10 such as that shown in FIG. 4, a hollow mandrel 12 comprising a cylindrical tube was angled about 20 degrees from horizontal was rotated at a rate of about 5 rpm. A continuous flow of molten glass was delivered to the interior of the hollow rotating mandrel 14 such that the molten glass contacted and coated the inside surface of the mandrel 16. The viscosity of the glass at the point of delivery 30 was about 4.4 kP. The temperature of the molten glass at the point of delivery 30 was about 1,100° C. The glass flowed longitudinally down the inside surface of the mandrel 16 at a flow rate of about 30 kg per hour. The tube preform was removed from the root end of the mandrel 22 and drawn using the conventional process described above to produce a glass tube. The inside surface of the glass tube was then tested via shadowgraphy, using an index-matching oil on the outside surface of the tube, and was shown to have no paneling defects.

### Example 2

Using an apparatus 10 such as that shown in FIG. 4, a hollow mandrel 12 angled about 45 degrees from horizontal was rotated at a rate of about 5 rpm. A continuous flow of molten glass was delivered to the interior of the hollow rotating mandrel 14 such that the molten glass contacted and coated the inside surface of the mandrel 16. The viscosity of the glass at the point of delivery 30 was about 4.4 kP. The temperature of the molten glass at the point of delivery 30 was about 1,100° C. The glass flowed longitudinally down the inside surface of the mandrel 16 at a flow rate of about 30 kg per hour. The tube preform was removed from the root end of the mandrel 22 and drawn using the conventional process described above to produce a glass tube. The inside surface of the glass tube was then tested via shadowgraphy, using an index-matching oil on the outside surface of the tube, and was shown to have no paneling defects.

### Example 3

Using an apparatus 10 such as that shown in FIG. 8, a hollow mandrel 12 angled about 60 degrees from horizontal was rotated at a rate of about 5 rpm. A continuous flow of molten glass was delivered to the interior of the hollow rotating mandrel 14 such that the molten glass contacted and coated the inside surface of the mandrel 16. The viscosity of the glass at the point of delivery 30 was about 4.4 kP. The temperature of the molten glass at the point of delivery 30 was about 1,100° C. The glass flowed longitudinally down the inside surface of the mandrel 16 at a flow rate of about 30 kg per hour. The tube preform was removed from the root end of the mandrel 22 and drawn using the conventional process described above to produce a glass tube. The inside surface of the glass tube was then tested via shadowgraphy, using an index-matching oil on the outside surface of the tube, and was shown to have no paneling defects.

### Example 4

Using an apparatus 10 such as that shown in FIG. 5, a hollow mandrel 12 comprising a cylindrical tube having a diameter of about 160 mm and a wall thickness of about 2 mm will be angled about 45 degrees from horizontal and rotated at a rate of about 5 rpm. A continuous flow of molten glass will be delivered to the interior of the hollow rotating mandrel 14 such that the molten glass contacts and coats the inside surface of the mandrel 16. The viscosity of the glass at the point of delivery to the inside surface of the mandrel 30 will be about 5 kP.

Simultaneously, a continuous flow of molten glass will be delivered to the outside surface 18 of the hollow rotating mandrel such that the molten glass contacts and coats the outside surface of the mandrel. The viscosity of the glass at the point of delivery to the outside surface of the mandrel 40 will also be about 5 kP.

The glass will flow longitudinally down the inside surface of the mandrel 16 and the outside surface of the mandrel 18 at a flow rate of about 60 kg per hour. A tube preform will continuously flow off from the root end of the mandrel 22 at a viscosity of about 150 kP. The preform will be continuously drawn using the conventional process described above to produce a glass tube. The glass tube will be tested via shadowgraphy and is expected to have no paneling defects on either the inside surface or the outside surface.

It will be apparent to those skilled in the art that various modifications and variations can be made without departing from the spirit or scope of the invention.

What is claimed is:

1. A method of making a glass tube comprising:
providing a flow of molten glass on an inner surface of a hollow rotating mandrel;
removing a glass tube preform from a downstream portion of the hollow rotating mandrel; and
drawing the preform to obtain a glass tube.

2. The method of claim 1, wherein the flow of molten glass is provided at a viscosity less than 30 kP.

3. The method of claim 2, wherein the flow of molten glass is provided at a viscosity less than 10 kP.

4. The method of claim 1, wherein the flow rate of the molten glass through the mandrel is between about 20 kg/h and about 800 kg/h.

5. The method of claim 1, wherein the mandrel defines a longitudinal axis, and the longitudinal axis is at an angle that is between about 5 degrees and about 90 degrees from horizontal.

6. The method of claim 1, wherein pressurized gas is introduced into the interior of the hollow rotating mandrel.

7. The method of claim 1, further comprising:
providing a flow of molten glass on an outer surface of the hollow rotating mandrel; and
wherein removing the glass tube preform from a downstream portion of the mandrel further comprises joining the flow of glass from the inner surface of the mandrel with the flow of glass from the outer surface of the mandrel.

8. The method of claim 7, wherein the glass on the outer surface of the mandrel has a different composition than the glass on the inner surface of the mandrel.

9. The method of claim 7, further comprising providing a flow of molten glass configured to provide an outer cladding layer; wherein the glass configured to provide an outer cladding layer has a different composition than the glass on the outer surface of the mandrel.

10. An apparatus for the making of glass tube comprising:
a mandrel, the mandrel comprising an outer surface and a hollow interior that is bounded by an inner surface, and the mandrel defining a longitudinal axis;
a delivery device configured to deliver molten glass to an inner surface of the mandrel; and
a device configured to rotate the mandrel;
wherein the apparatus is configured such that the glass flows longitudinally to an exit point at a downstream end of the mandrel.

11. The apparatus of claim 10 further comprising a device configured to deliver gas to the hollow interior of the mandrel.

12. The apparatus of claim 10 further comprising a cooling device configured to cool the inner surface of the mandrel.

13. The apparatus of claim 12, wherein the cooling device comprises a cooling element located within the wall of the mandrel.

14. The apparatus of claim 10, wherein the mandrel is cylindrical.

15. The apparatus of claim 10, wherein the mandrel is conical.

16. The apparatus of claim 10, wherein the longitudinal axis forms an angle that is between about 45 degrees and about 90 degrees from horizontal.

17. The apparatus of claim 16, wherein the inner surface of the mandrel comprises a first portion and a second portion, and wherein
the first portion of the inner surface of the mandrel is sloped inward to provide an angle from horizontal that is less than the angle formed by the longitudinal axis.

18. The apparatus of claim 10 further comprising a delivery device configured to deliver molten glass to an outer surface of the hollow mandrel; and
wherein the apparatus is further configured such that glass flows off the outer surface of the mandrel at the downstream end of the mandrel.

19. The apparatus of claim 18, wherein the delivery device configured to deliver molten glass to an inside surface of the hollow mandrel comprises
the device configured to deliver molten glass to the outer surface of the mandrel; and
one or more openings in the mandrel wall, the one or more openings being configured to provide for the flow of molten glass from the outer surface of the mandrel to the inner surface of the mandrel.

20. The apparatus of claim 18, wherein
the longitudinal axis forms an angle that is between about 45 and about 90 degrees from horizontal and wherein the mandrel is configured;
the outer surface of the mandrel comprises a first portion and a second portion; and
the first portion of the outer surface of the mandrel is sloped outward to provide an angle from horizontal that is less than the angle formed by the longitudinal axis.

21. The method of claim 1, wherein the mandrel is rotated at a rate between about 2 and about 20 revolutions per minute.

22. The method of claim 21, wherein the mandrel is rotated at a rate between about 2 and about 10 revolutions per minute.

23. The method of claim 1, wherein the viscosity of the molten glass tube preform exiting the downstream portion of the mandrel has a viscosity between about 80 kP and about 300 kP.

24. The method of claim 23, wherein the viscosity of the molten glass tube preform exiting the downstream portion of the mandrel has a viscosity between about 100 kP and about 200 kP.

25. The method of claim 1, further comprising providing a flow of gas inside the hollow mandrel.

26. The method of claim 25, wherein the pressure of the gas flow inside the hollow mandrel is between about 1 Pa and about 1000 Pa.

27. The method of claim 26, wherein the pressure of the gas flow inside the hollow mandrel is between about 1 Pa and about 500 Pa.

28. The method of claim 27, wherein the pressure of the gas flow inside the hollow mandrel is between about 1 Pa and about 300 Pa.

29. The method of claim 1, wherein the glass tube has an interior surface that is substantially free from paneling defects.

30. The method of claim 29, wherein the glass tube has an interior surface that is pristine.

31. The method of claim 7, wherein the glass tube has an exterior surface that is substantially free from paneling defects.

32. The method of claim 31, wherein the glass tube has an exterior surface that is pristine.

33. The method of claim 31, wherein the glass tube has an interior surface that is substantially free from paneling defects.

34. The method of claim 32, wherein the glass tube has an interior surface that is pristine.

35. The method of claim 1, wherein the glass tube has an outer diameter between about 10 mm and about 60 mm.

36. The method of claim 35, wherein the glass tube has a wall thickness between about 0.5 mm and about 2 mm.

37. The method of claim 1, wherein the thickness of the glass tube varies by less than 5%.

38. The method of claim 1, wherein the thickness of the glass tube varies by less than 2%.
